(19) United States
(12) Patent Application Publication
(10) Pub. No.: US 2023/0332461 A1
(43) Pub. Date: Oct. 19, 2023

(54) VENETIAN BLIND

(71) Applicant: UNION WINNER INTERNATIONAL CO., LTD., TAIPEI CITY (TW)

(72) Inventor: Ming-Tsung PAI, CAOTUN TOWNSHIP (TW)

(73) Assignee: UNION WINNER INTERNATIONAL CO., LTD., TAIPEI CITY (TW)

(21) Appl. No.: 18/336,628

(22) Filed: Jun. 16, 2023

Related U.S. Application Data
(63) Continuation-in-part of application No. 16/589,628, filed on Oct. 1, 2019.

(51) Int. Cl. E06B 9/303; E06B 9/38

(52) U.S. Cl. CPC E06B 9/303; E06B 9/38

(57) ABSTRACT

A venetian blind includes a top rail and a bottom rail linked by two ladder ropes. The ladder rope has a first vertical portion, a second vertical portion, transverse portions connected between the first and second vertical portions, and loop portions connected to the first vertical portion. The slat is supported by the transverse portion and has two holes, two openings, and two slots communicating between the holes and the openings. The loop portions penetrate into the holes from the openings through the slots so as to be mounted around one long edges of the slats. The peripheral wall of the hole has a guiding surface and a positioning portion. When the slats are tilted from a horizontal position to a tilted position, the loop portions are moved along the guiding surfaces to the positioning portions. As such, the present invention is structurally simple and easy to be assembled.

### CROSS-REFERENCE TO RELATED APPLICATIONS

This application is a Continuation-in-Part of copending application Ser. No. 16/589,628, filed on Oct. 1, 2019, which is hereby expressly incorporated by reference into the present application.

### BACKGROUND OF THE INVENTION

### 1. Field of the Invention

The present invention relates to venetian blinds and more particularly, to a venetian blind that is structurally simple and easy to be assembled.

### 2. Description of the Related Art

U.S. Pat. No. 7,556,080B2 discloses a window blind that has a plurality of connectors. Each of the connectors passes through the holes formed on the slats from above. Each of the connectors has a first end connected to the rear vertical portion of the ladder, and each of the connectors has a second end formed with a loop portion for a lifting cord to pass therethrough, so that the lifting cord can only be moved vertically but not transversely. In addition, after passing through the holes of the slats, the second end of the connector can be provided with a stopper formed by a metal sheet or a knot to prevent the connector from slipping off the slats.

In the prior patent, however, although the connector is flexible, the small hole diameter makes it time-consuming to pass the connector through the hole from above. Further, after the time-consuming threading operation, there is an additional step to use the metal sheet to hold the second end of the connector or to knot the second end of the connector, making the overall assembling work more difficult. Once any of the assembled slats gets damaged and needs to be replaced, it is necessary to detach the metal sheet or unknot the second end before taking further maintenance or repair actions. Hence, the prior patent is inconvenient in terms of assembling, and improvement is therefore desirable.

### SUMMARY OF THE INVENTION

It is a primary objective of the present invention to provide a venetian blind that is structurally simple and easy to be assembled, in which its slats are prevented from excessive transverse displacement.

To attain the above objective, the venetian blind comprises a top rail, a bottom rail, a bottom rail located below the top rail, two ladder ropes connected between the upper and bottom rails, and a plurality of slats positioned between the upper and bottom rails and disposed on the transverse portions of the ladder ropes. The ladder ropes each have a first vertical portion, a second vertical portion opposite to the first vertical portion, a plurality of transverse portions connected between the first and second vertical portions and arranged in an equidistant manner along the first and second vertical portions, and a plurality of loop portions connected to the first vertical portion. The slats each have a top surface, a bottom surface opposite to the top surface, a first long edge caught by the loop portions of the ladder ropes, a second long edge adjacent to the second vertical portions of the ladder ropes, two holes through the top and bottom surfaces and penetrated by the loop portions of the ladder ropes, two openings formed at the first long edge for allowing the loop portions to enter and exit, and two slots through the top and bottom surfaces and each communicating between the hole and the opening for guiding the loop portion to move from the hole to the opening or from the opening to the hole. Further, a peripheral wall of each of the holes has a guiding surface and a positioning portion. When the slats are tilted from a horizontal position to a tilted position, the loop portions are moved along the guiding surfaces to the positioning portions, and when the slats are located at the tilted position, the loop portions are positioned in the positioning portions of the slats.

It can be seen from the above that with the holes, the openings and the slots of the slats, the venetian blind of the present invention allows the ladder ropes to be assembled with the slats conveniently and firmly without using other tools: meanwhile, the damaged slats are easily disassembled from the ladder ropes for repair or replacement. Further, the venetian blind of the present invention prevents the slats from excessive transverse displacement through the loop portions and the holes, such that the venetian blind of the present invention can eliminate traditional lift cords to provide a simple structure.

Preferably, the peripheral wall of each of the holes has two said guiding surfaces. When the slats are tilted from the horizontal position to the tilted position, each of the loop portions is moved along one of the guiding surfaces to the positioning portion.

Preferably, the positioning portion is formed at a junction of the two guiding surfaces. A distance between the two guiding surfaces gradually increases away from the positioning portion.

Preferably, the slots each have a first guiding section communicating with the hole and extending along a longitudinal direction of the slat, and a second guiding section connected with the first guiding section and communicating with the opening and extending along a width direction of the slat.

Preferably, a chamfer is formed at a junction of the first and second guiding sections to avoid interference between the loop portion and the slot.

Preferably, the loop portions each have two ends thereof connected to the first vertical portion of the ladder rope and located at the same side of the transverse portion of the ladder rope.

Preferably, the loop portions each have two ends thereof connected to the first vertical portion of the ladder rope and located at the opposite side of the transverse portion of the ladder rope.

Preferably, the openings each have a width gradually decreasing toward the slot. In this way, the loop portion is easy to enter the slot through the opening.

Preferably, the two slots are arranged in a transversely symmetrical. In this way, it is easier for the slats to be positioned.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a venetian blind of the present invention, showing that the slats are in a horizontal position.

FIG. 2 is another perspective view of a venetian blind of the present invention, showing that the slats are in a horizontal position.

FIG. 3 is an enlarged view of part A of FIG. 1.

FIG. 4 is a partially top view of the venetian blind of the present invention.

FIG. 5 is similar to FIG. 4, showing that the bottom end of the loop portion is located at the opposite side of the transverse portion.

FIG. 6 is similar to FIG. 4, showing that the slot extends in an inclined manner.

FIG. 7 is a partially perspective view of the venetian blind of the present invention, showing that the loop portion of the ladder rope is penetrated into the holes of the two adjacent slats.

FIG. 8 is a perspective view of a venetian blind of the present invention, showing that the slats are in a tilted position.

FIG. 9 is a partially cross-sectional view of the venetian blind of the present invention, showing that the slats are in a tilted position.

FIG. 10 is similar to FIG. 1, showing that the slats are in a tilted position, showing that the loop portion of the ladder rope is moved along the positioning portion of the slat.

FIG. 11 is similar to FIG. 10, showing that the loop portion of the ladder rope is positioned in the positioning portion of the slat.

FIG. 12 is a perspective view of the venetian blind of the present invention, showing that the slots are arranged in a transversely symmetrical.

FIG. 13a is a plane view of the venetian blind of the present invention, showing that one of the slats is pulled horizontally.

FIG. 13b is similar to FIG. 13a, showing that the slats are aligned with each other.

### DETAILED DESCRIPTION OF THE INVENTION

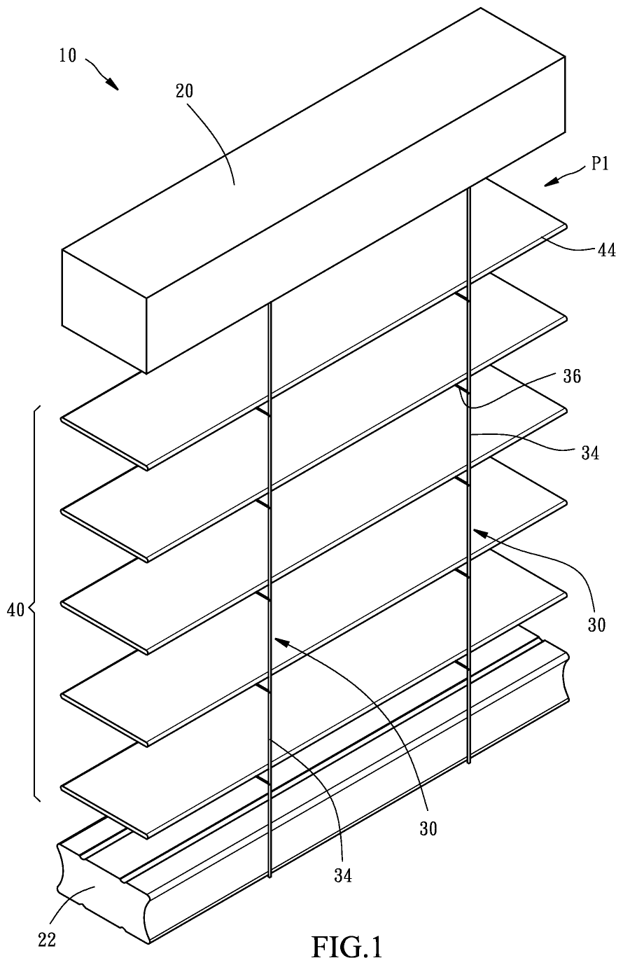

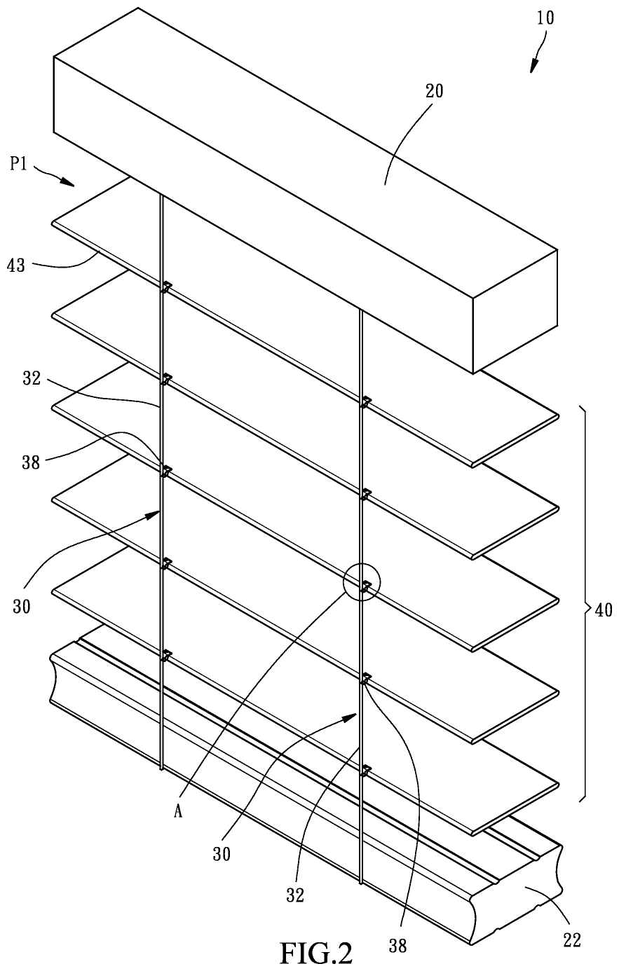

Referring to FIGS. 1 and 2, a venetian blind 10 of the present invention comprises a top rail 20, a bottom rail 22, two ladder ropes 30, and a plurality of slats 40 (the number is not limited herein).

The top rail 20 and the bottom rail 22 are arranged in an up-down manner.

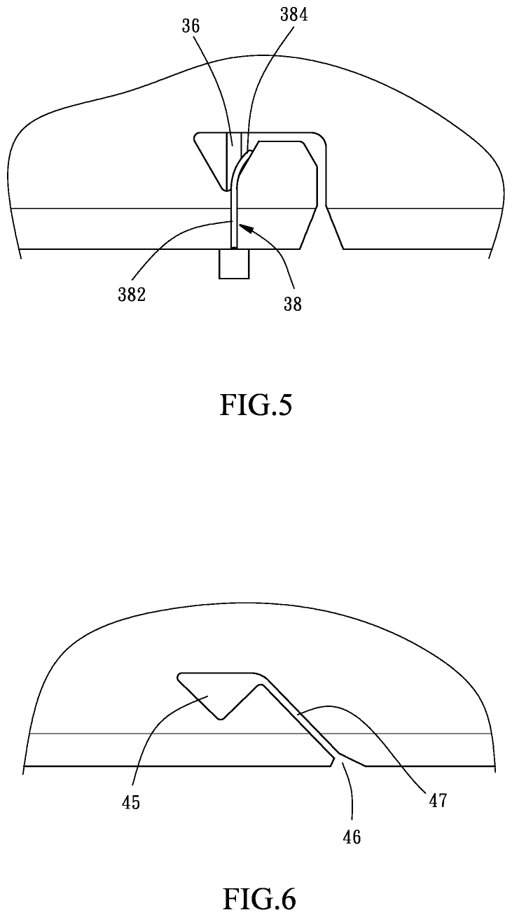

The two ladder ropes 30 are connected between the top rail 20 and the bottom rail 22. Each of the ladder ropes 30 has a first vertical portion 32, a second vertical portion 34, a plurality of transverse portions 36, and a plurality of loop portions 38. As shown in FIGS. 1 and 2, the first vertical portion 32 and the second vertical portion 34 are opposite to each other, and both have their respective tops extending into the top rail 20 to be connected with an angle adjusting mechanism (not shown) for adjusting the tilt angle of the slats 50. Since the angle adjusting mechanism is known in the prior art and not the characteristic of the present invention, the detail thereof is omitted herein. The transverse portions 36 are connected between the first and second vertical portions 32, 34 by means of sewing or weaving and arranged in an equidistant manner along the first and second vertical portions 32, 34. The loop portions 38 each have a first end 382 and a second end 384. The first and second ends 382, 384 are connected to the first vertical portion 32 by means of sewing or weaving and located at the same side or opposite side of the transverse portion 36, as shown in FIGS. 4 and 5.

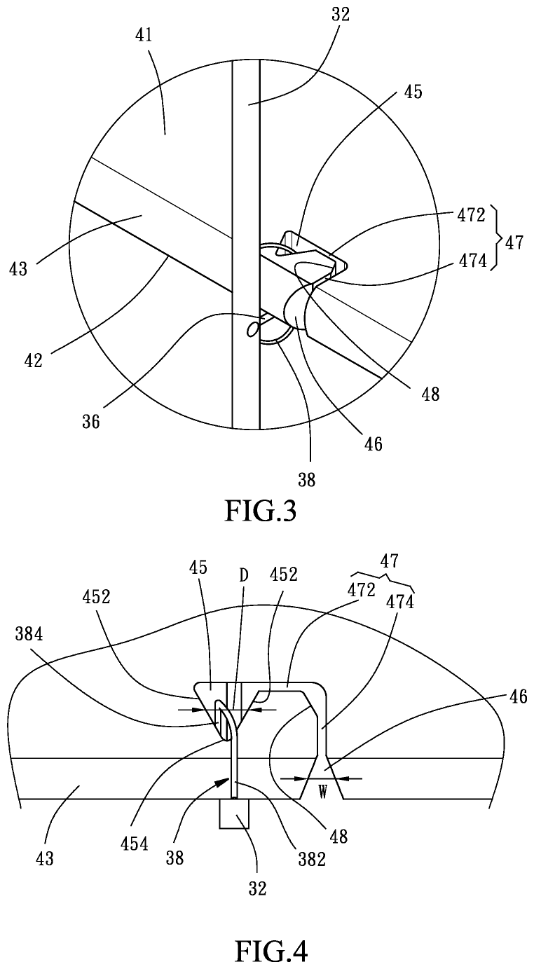

As shown in FIGS. 3 and 4, the slats 40 each have a top surface 41, a bottom surface 42 opposite to the top surface 41, a first long edge 43, a second long edge 44 opposite to the first long edge 43, two holes 45 through the top and bottom surfaces 41,42, two openings 46 formed at the first long edge 43, and two slots 47 through the top and bottom surfaces 41, 42 and each have a first guiding section 472 communicating with the hole 45 and extending along the longitudinal direction of the slat 40, and a second guiding section 474 connected with the first guiding section 472 and communicating with the opening 46 and extending along the width direction of the slat 40, wherein the peripheral wall of each of the holes 45 has two guiding surfaces 452 (at least one is sufficient) and a positioning portion 454 formed at a junction of the two guiding surfaces 452. A distance D between the two guiding surfaces 452 gradually increases away from the positioning portion 454.

What needs to be added here is that the hole 45 can have different geometrical shapes, such as triangle, circular, semicircular, quadrangle or hexagon. In this embodiment, the hole 45 has a triangular shape.

To assemble the ladder rope 30 and the slats 40, as shown in FIGS. 3 and 4, the slats are parallel to each other and arranged between the top rail 20 and the bottom rail 22, and further, each of the slats 40 is supported by the transverse portions 33 of the two ladder ropes 30 in such a way that the first long edges 43 of the slats 40 are adjacent to the first vertical portions 32 of the ladder ropes 30 and the second long edges 44 of the slats 40 are adjacent to the second vertical portions 34 of the ladder ropes 30. Thereafter, the loop portion 38 of the ladder rope 30 is inserted into the second guiding section 474 of the slot 47 through the opening 46, and then moved to the first guiding section 472 of the slot 47 from the second guiding section 474 of the slot 47, and then penetrated into the hole 45 of the slat 40 from the first guiding section 472 of the slot 47, so that the loop portion 38 of the ladder rope 30 is mounted around the first long edge 43 of the slat 40 to complete assembly of the ladder rope 30 and the slat 40. What needs to be added here is that the openings 46 each have a width W gradually decreasing toward the slot 47 to permit the loop portions 38 to easily enter the openings 46, and further, a chamfer 48 is formed at a junction of the first and second guiding sections 472, 474 to make it easier for the loop portion 38 to move from the second guiding section 474 to the first guiding section 472 without interfering with the slot 47.

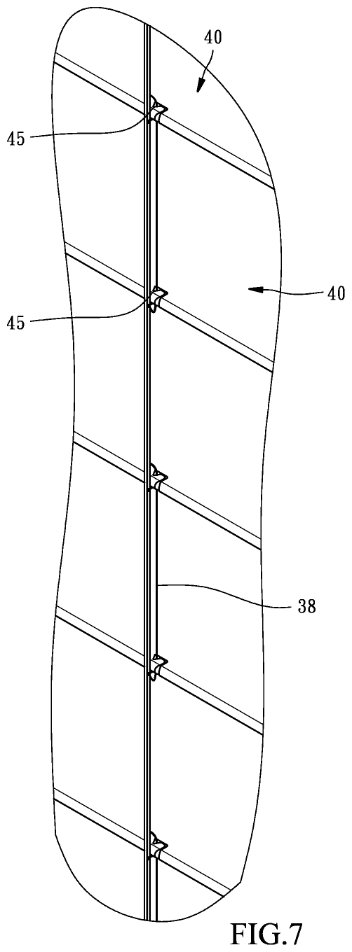

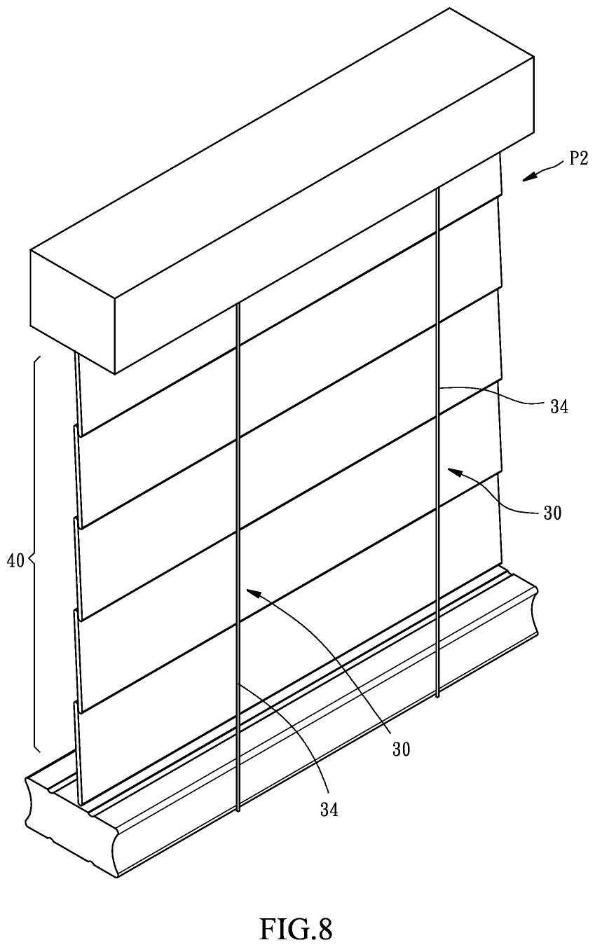

It is worth mentioning that in this embodiment, each of the loop portions 38 of the ladder ropes 30 is penetrated into one of the holes 45 of the slat 40. However, each of the loop portions 38 of the ladder ropes 30 can be penetrated into the holes 45 of the two adjacent slats 40, as shown in FIG. 7. Further, the slot 47 is not limited to be formed by the first guiding section 472 and the second guiding section 474. As shown in FIG. 6, the slot 47 can be formed in an inclined manner for guiding the loop portion 38 to move.

As the ladder rope 30 and the slat 40 are such assembled, the slat 40 is prevented from excessive transverse displacement, and further, since the slot 47 is in a reversed-L shape, even when the assembled slat 40 is lifted, lowered or tilted, the loop portion 38 of the ladder rope 30 inserted in the hole 45 is difficult to move into the first guiding section 472 of the slot 47, thereby effectively preventing the loop portion 38 of the ladder rope 30 from accidentally coming off the slat 40.

Replacement of a damaged slat 40 can be easily achieved by pulling the loop portion 38 of the ladder rope 30 inserted in the hole 45 of the damaged slats 40 out of the hole 45 through the slot 47 and the opening 46, and having a new slat 50 assembled with the loop portion 38 of the ladder rope 30 as described above. The replacement is simple and rapid.

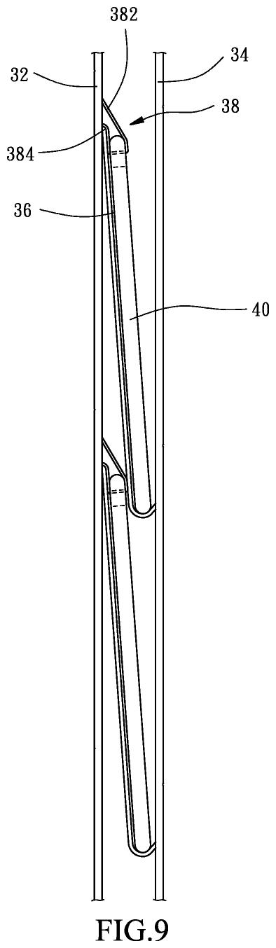

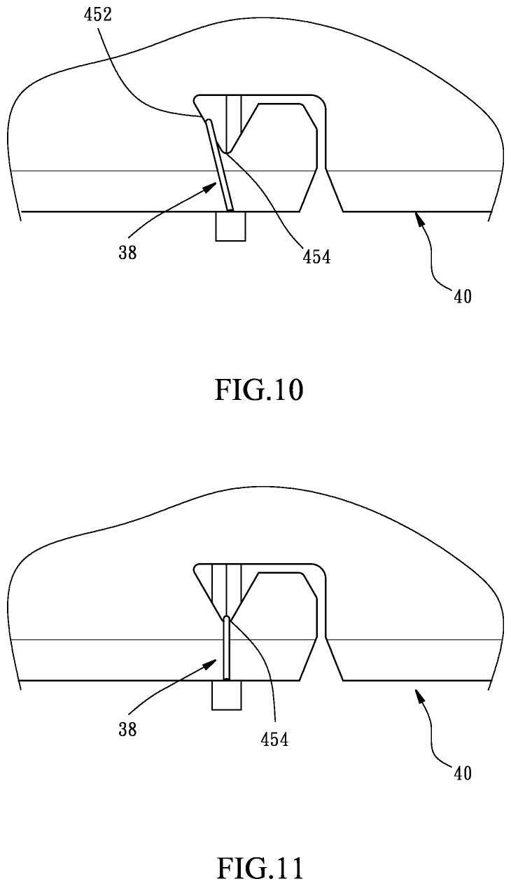

Moreover, when the slats 40 are tilted from a horizontal position P1 as shown in FIG. 1 to a tilted position P2 as shown in FIGS. 8 and 9, the loop portions 38 of the ladder ropes 30 are moved along one of the two guiding surfaces 452 to the positioning portions 454 (as shown in FIGS. 10 and 11) by the staggered arrangement of the holes 45 and the loop portions 38. During movement of the loop portions 38 of the ladder ropes 30, the slats 40 are aligned automatically to each other. Once the slats 40 are located at the tilted position P2 as shown in FIG. 11, the loop portions 38 of the ladder ropes 30 are positioned in the positioning portions 454 of the slats 40. At this time, each two adjacent slats 40 are closer to each other, thereby minimizing the interval therebetween that may allow light to leak in, and in turn improving the light-shading effect.

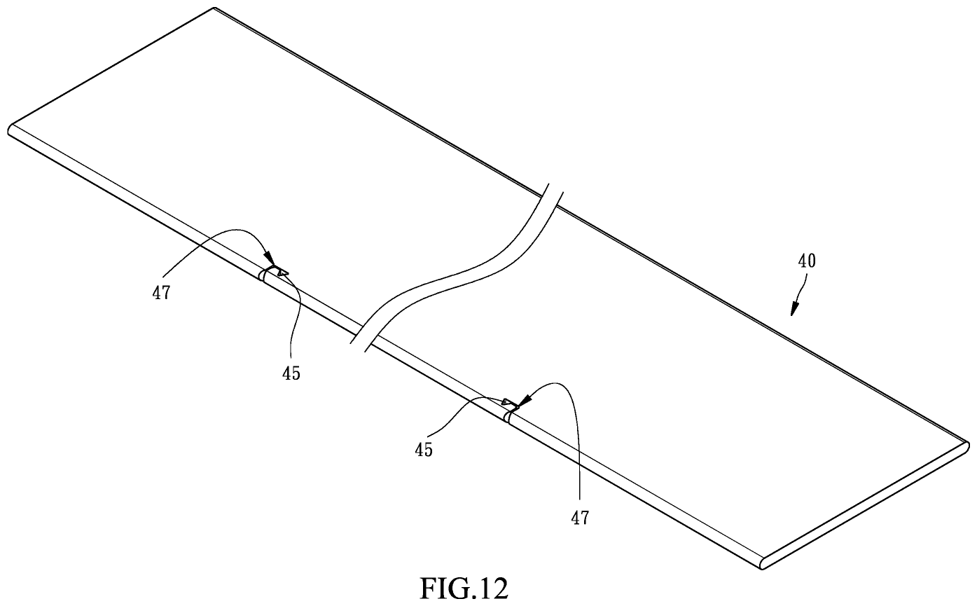

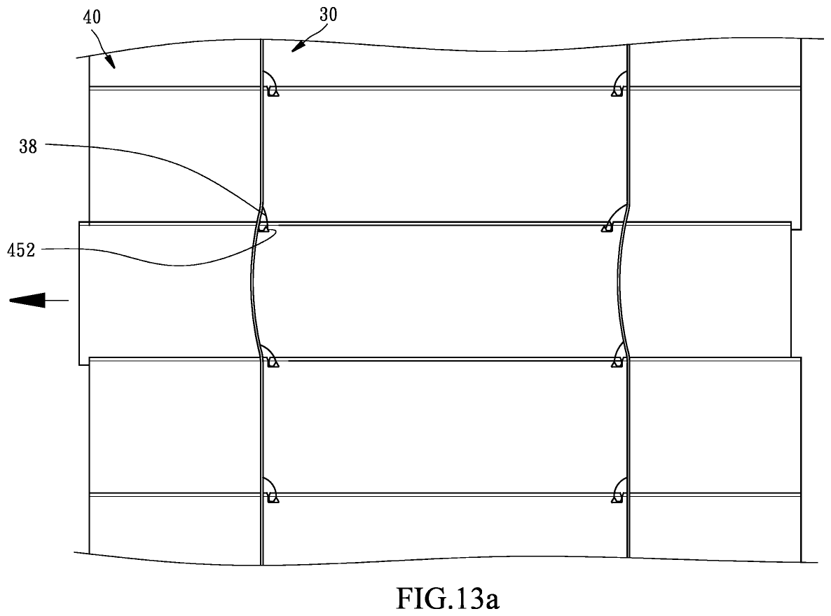

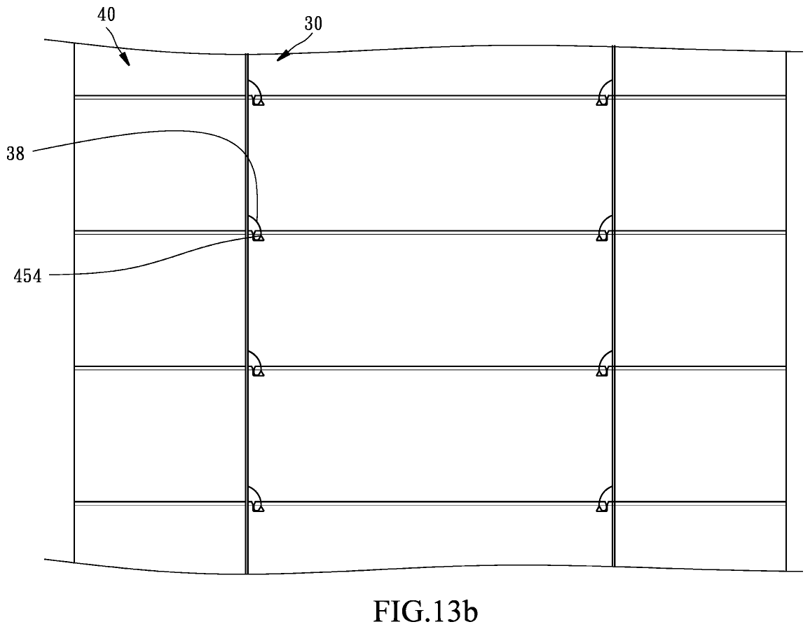

Furthermore, as shown in FIG. 12, the two slots 47 can be arranged in a transversely symmetrical. In this way, as shown in FIGS. 13a and 13b, by means of movement of the loop portions 38 of the ladder ropes 30 along the guiding surfaces 452 to the positioning portions 454, the slats 40 are easier to be aligned automatically to each other, and further, the loop portions 38 are not easier to separate from the slats 40. As indicated above, the venetian blind 10 of the present invention uses the holes 45, the openings 46, and the slots 47 to have the ladder ropes 30 assembled with the slats 40 conveniently and firmly without using any knot or other components and guide the slats 40 to be aligned automatically; meanwhile, the slats 40 can be easily disassembled from the ladder ropes 30 to replace any damaged slats 40.

What is claimed is:

1. A venetian blind comprising:
a top rail;
a bottom rail located below the top rail;
two ladder ropes connected between the upper and bottom rails, the ladder ropes each having a first vertical portion, a second vertical portion opposite to the first vertical portion, a plurality of transverse portions connected between the first and second vertical portions and arranged in an equidistant manner along the first and second vertical portions, and a plurality of loop portions connected to the first vertical portion; and
a plurality of slats positioned between the upper and bottom rails and disposed on the transverse portions of the ladder ropes, the slats each having a top surface, a bottom surface opposite to the top surface, a first long edge caught by the loop portions of the ladder ropes, a second long edge opposite to the first long edge and adjacent to the second vertical portions of the ladder ropes, two holes through the top and bottom surfaces and penetrated by the loop portions of the ladder ropes, two openings formed at the first long edge for allowing the loop portions to enter and exit, and two slots through the top and bottom surfaces and each communicating between the hole and the opening for guiding the loop portion to move between the hole and the opening, wherein a peripheral wall of each of the holes has a guiding surface and a positioning portion, and when the slats are tilted from a horizontal position to a tilted position, the loop portions are moved along the guiding surfaces to the positioning portions, and when the slats are located at the tilted position, the loop portions are positioned in the positioning portions.

2. The venetian blind as claimed in claim 1, wherein the peripheral wall of each of the holes has two said guiding surfaces; when the slats are tilted from the horizontal position to the tilted position, each of the loop portions is moved along one of the guiding surfaces to the positioning portion.

3. The venetian blind as claimed in claim 2, wherein the positioning portion is formed at a junction of the two guiding surfaces; a distance between the two guiding surfaces gradually increases away from the positioning portion.

4. The venetian blind as claimed in claim 1, wherein the slots each have a first guiding section communicating with the hole and extending along a longitudinal direction of the slat, and a second guiding section connected with the first guiding section and communicating with the opening and extending along a width direction of the slat.

5. The venetian blind as claimed in claim 4, wherein a chamfer is formed at a junction of the first and second guiding sections.

6. The venetian blind as claimed in claim 1, wherein the loop portions each have two ends thereof connected to the first vertical portion of the ladder rope and located at the same side of the transverse portion of the ladder rope.

7. The venetian blind as claimed in claim 1, wherein the loop portions each have two ends thereof connected to the first vertical portion of the ladder rope and located at the opposite side of the transverse portion of the ladder rope.

8. The venetian blind as claimed in claim 1, wherein the openings each have a width gradually decreasing toward the slot.

9. The venetian blind as claimed in claim 1, wherein the two slots are arranged in a transversely symmetrical.

10. The venetian blind as claimed in claim 1, wherein each of the slots extend inclinedly.

11. The venetian blind as claimed in claim 1, wherein each of the loop portions of the ladder ropes passes through one of the holes of the slat.

12. The venetian blind as claimed in claim 1, wherein each of the loop portions of the ladder ropes passes through the holes of the two adjacent slats.
